(19) United States
(12) Patent Application Publication
(10) Pub. No.: US 2017/0083971 A1
(43) Pub. Date: Mar. 23, 2017

(54) GARMENT FILTERING AND PRESENTATION METHOD USING BODY SCAN INFORMATION

(71) Applicant: MPORT PTY LTD, Macquarie Park (AU)

(72) Inventors: Dipra RAY, Macquarie Park (AU); Melody SHIUE, Macquarie Park (AU); Tsung Yuan WU, Macquarie Park (AU); John QUINN, Macquarie Park (AU); Ilya ANIKUSHIN, Gordon (AU)

(21) Appl. No.: 15/311,017

(22) PCT Filed: May 13, 2015
(86) PCT No.: PCT/AU2015/000278

§ 371 Date: Nov. 14, 2016

(30) Foreign Application Priority Data
May 13, 2014 (AU) 2014901773
May 13, 2014 (AU) 2014901774
May 13, 2014 (AU) 2014901775
May 13, 2014 (AU) 2014901777

(51) Int. Cl. G06Q 30/06; G06T 13/40

(52) U.S. Cl. CPC G06Q 30/0643; G06T 13/40

(57) ABSTRACT

Centralized management of data of three dimensional body scanning image data obtained from distributed scanning booths. The website provides for secure login and the ability to make comparisons to garment sizes using data derived from both the size and shape obtained from the 3D body scan. Online product viewing of the filtered results is available, as well, as ability to order third party alterations of standard garments based on the user sizing data.

### FIELD OF THE INVENTION

The present invention relates to technology and functionality provided in the context of a framework that enables management of data derived from three dimensional body scanning. Some embodiments relate to frameworks and methodologies configured to enable third party alteration of garments (or configuration of other products/services) obtained from an online vendor based on centralised management of user sizing data derived from body scanning. Some embodiments relate to delivery of mobile-app based promotions driven by data derived from three dimensional body scans. Some embodiments relate to frameworks and methodologies for enabling user to garment size comparison information via centralized management of data derived from three dimensional body scans. Some embodiments relate to filtering of web results and/or filtering display of inventory items in online product viewing and/or purchase platforms via centralized management of data derived from three dimensional body scans.

Although various example described herein relate to clothing and garments, the technology is not limited as such, and is also applied in respect of various other goods and services where user size information is of relevance.

### BACKGROUND

Any discussion of the prior art throughout the specification should in no way be considered as an admission that such prior art is widely known or forms part of common general knowledge in the field.

Body size and shape information is highly useful in a range of situations, including selection and sizing of clothing, and monitoring of health and/or fitness. Various known hardware devices enable determination of such information, resulting in the generation of digital data which represents. However, in spite of hardware availability, there are significant challenges in providing solutions which enable widespread consumer utilisation of such data in a convenient manner.

### SUMMARY OF THE INVENTION

One embodiment provides a computer implemented method including:

receiving, via a widget embedded in a garment vendor web page, data indicative of a garment purchased by a user; and

providing to a alteration service provider data indicative of the garment and data indicative of sizing information for the user, wherein the sizing information is derived from centrally management body scan information.

One embodiment provides a method for coordinating alteration of garments, the method including:

maintaining a repository of sizing information for users, wherein the sizing information is derived from body scans performed at a plurality of distributed locations;

maintaining communication with a plurality of online vendor portals which enable purchase of garments; and

enabling a given user of a given vendor portal to request alteration of a given purchased garment via the vendor portal; and

defining data indicative of instructions for alteration of the garment by a alteration service provider, wherein the instructions include sizing information for the user.

One embodiment provides a computer implemented method including:

determining current location information for a mobile device on which a mobile-app is executing;

presenting data indicative of one or more promotions, wherein the one or more promotions are selected based upon:

(i) the determined current location;

(i) data derived from body scan information managed at a central server, which maintains body scan information for a plurality of users collected from a plurality of body scanning hardware units; and

(iii) vendor promotional parameters.

One embodiment provides a system configured for performing a method as described herein.

One embodiment provides a computer implemented method for managing body scan information, the method including:

receiving, from a plurality of distributed scanning booth systems, body scan data respectively defined for a plurality of users;

maintaining user record data, wherein the user record data is configured to include, for each of a plurality of users, user registration data and user body scan data; and

providing a user interface functionality, viewable via a third party platform, which enables a given user to view a relationship between the user's size, as determined from user body scan data, and a garment size.

One embodiment provides a computer implemented method for displaying garment information to a user, the method including:

providing an interface that enables the user to view garment information;

identifying the user;

communicating with a remote server that maintains access to user record data, wherein the user record data is configured to include, for each of a plurality of users, user registration data and user body scan data; and

providing a user interface object which enables the user to view a relationship between the user's size, as determined from user body scan data, and a garment size.

One embodiment provides a system configured for performing a method as described herein.

One embodiment provides a computer implemented method for managing body scan information, the method including:

receiving, from a plurality of distributed scanning booth systems, body scan data respectively defined for a plurality of users;

maintaining user record data, wherein the user record data is configured to include, for each of a plurality of users, user registration data and user body scan data; and

providing a user interface functionality, viewable via a third party platform, which enables filtering of garments for display to a given user based on the user's size as derived from the body scan data.

One embodiment provides a computer implemented method for displaying garment information to a user, the method including:

providing an interface that enables the user to view garment information;

identifying the user;

communicating with a remote server that maintains access to user record data, wherein the user record data is configured to include, for each of a plurality of users, user registration data and user body scan data; and

filtering of garments for display to a given user based on the user's size as derived from the body scan data.

One embodiment provides a system configured for performing a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of

It will be appreciated that any of the features of the methods and systems described herein can be provided independently or any combination with each other.

Furthermore, it will be appreciated that the methods and systems described herein can provide numerous advantages, including, but not limited to providing a system and method which can accurately measure a physical body and provide an accurate anatomically realistic representation of the physical body, typically in an image form. The image of the physical body and associated data generated (for example scanned information or measurement data) can be used to provide certain recommendations to the user of the physical body. In one example, these include fashion and/or health recommendations, although it will be appreciated that other applications of the system and method described herein also fall within the scope of this document.

The content of WO 2014/183157 is incorporated by cross reference.

### BRIEF DESCRIPTION OF THE DRAWINGS

Embodiments of the technology are further described by way of example with reference to the accompanying drawings.

FIG. 1A to FIG. 1C illustrate system arrangements according to various embodiments.

FIG. 2A to FIG. 2D illustrates methods according to various embodiments.

FIG. 3 illustrates a client-server framework.

### DETAILED DESCRIPTION

Described herein is technology including frameworks and methodologies configured to enable third party alteration of garments obtained from an online vendor based on centralised management of user sizing data derived from body scanning.

### General Overview

The technology herein described relates to distributed collection and utilisation of body scan data, primarily body size and shape information. This data is collected via distributed hardware devices, which may include autonomous scanning booths and/or other scanning hardware (including from image-based, stereoscopic, microwave, infrared, and other scanning technologies).

In some embodiments a scanning booth includes user interface components which implement a predefined logical process thereby to guide a user though a scanning procedure. Body scan data is then uploaded to a central server, and via this server is made available to one or more third party platforms, such as websites and software applications (for example using APIs, widgets, and the like). This enables the third party platforms to implement functionalities which leverage body scan data. Examples of such functionalities include selection of appropriately sized clothing, monitoring of health and fitness, rating/ranking, competitions, and so on.

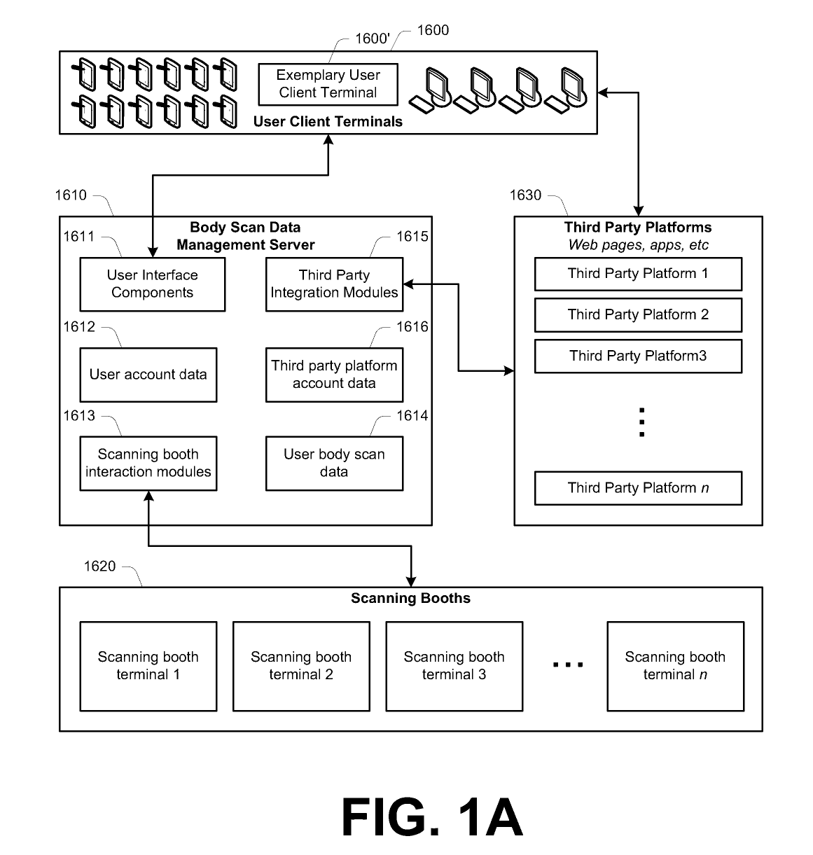

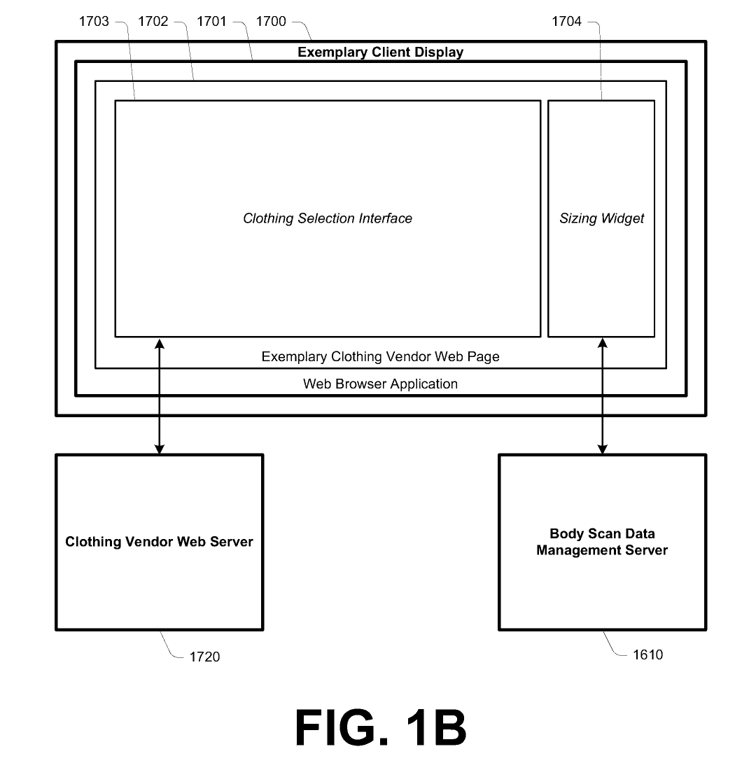

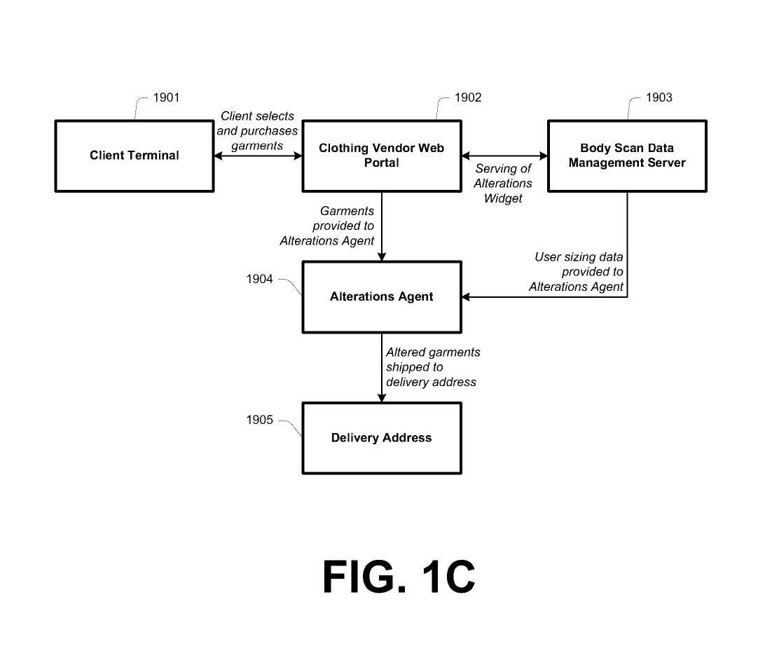

FIG. 1A illustrates an overall framework according to one embodiment. Exemplary implementations of various components within this framework are described in more detail further below.

FIG. 1A centres around a body scan data management server 1610. This server may, in practical embodiments, be defined by one or more individual computing devices, optionally distributed over a number of physical locations. Server 1610 is configured to communicate with:
User client terminal 1600, which may include the likes of personal computers, notebooks, smartphones, tablets, gaming consoles, and the like. For example, these client terminals execute respective web browser applications, which enable local rendering of user interface components provided by a user interface component module 1611 of server 1610. These user interface components provide users with access to functionalities native to server 1610, which preferably includes account management (for example registration of a new account, and modification of existing account details, with user account data being maintained in a repository 1612) and in some cases scan management (for example modification of avatars, deletion of scan data, and so on).
Scanning booths 1620, which may include user-driven autonomous booths (such as those described below) and in some embodiments other scanning booths. Scanning booth interaction modules 1313 are responsible for enabling interaction between scanning booths 1620 and server 1610. This may include user account data management (for example where a user is enabled to register and/or login via a user interface provided at a scanning booth terminal), terminal maintenance (for example monitoring, downloading of software patches/updates), serving of advertising and/or promotional content, and so on.
Third party platforms 1630, which may include the likes of websites, proprietary software applications (including, but not limited to, mobile apps). Third party integration modules 1615 allow server 1610 to communicate with each of platforms 1630, preferably via a plurality of technological approaches. This may include widget based approaches (where code served by server 1601 is embedded within a web page provided by one of platforms 1630 and rendered at a given one of client terminals 1600, API-based approaches (whereby a third party platform communicates with and interacts with server 1610 via a predefined communications protocol), and other approaches.

Third party platform account data 1616 include data specific to each third party platform, thereby to allow either or both of (i) monetisation of services provided to those platforms on a monitored (for example per-use) basis; and (ii) maintaining platform-specific information (such as garment sizing data) thereby to allow tailored customisation of data and/or functionality provided via modules 1615.

Various examples of widgets and other functionalities provided by server 1610 to platforms 1630 are discussed in additional detail further below.

Autonomous User-Driven Scanning Overview

Embodiments described herein are primarily focussed on arrangements whereby scanning booths provide autonomous user-driven scanning. This means that a scanning booth provides user interface and user stimuli components which implement a logical process thereby to guide a user through a body-scanning procedure without intervention by a second human user. That is, a user is enabled to approach a booth, and have a user interface guide them through an entire scanning process, from login (or registration in the context of a non-registered user) through to scan completion (and in some embodiments avatar approval).

In general terms, a scanning booth configured to provide an autonomous user-driven scanning includes the following components:
A user interface which provides a user interface thereby to enable a user to identify with the booth. This may include either or both of local registration (i.e. provision of personal information and the like thereby to create a new user account) and user login. A user login may include. providing user credentials, such as a username and password, defined subject to a previous local registration or a previous remote registration (using a terminal 1600 in communication with server 1610).
A user interface and associated stimuli devices (for example visual and/or audible stimuli devices) configured to enable delivery of user instructions, thereby to enable a scan. These instructions include (i) preparation (for example clothing removal), (ii) stance and posture (for example positioning relative to defined feet positions and body position, preferably assisted by way of visual stimuli and automated feedback), and other such instructions. This allows automated scanning hardware (preferably in the form of infrared sensors) to collect body scan data from a body that is in a predefined desired stance and position. It will be appreciated that this greatly assists in analysis of collected measurements.
Scanning components, such as infrared sensors, which are configured to make body scan measurements. These measurements are used thereby facilitate downstream functionalities, for example avatar generation.
A user interface which guides a user through avatar generation and approval. Following approval, body scan data is transmitted to server 1610 thereby to be available for downstream use.

The user interfaces described above may be delivered by one or more screens, driven by one or more computing terminals.

### Exemplary Sizing Widget

FIG. 1B illustrates an arrangement whereby a sizing widget is embedded into a third party website. More specifically, FIG. 1B represents an exemplary client display 1700 (which may be the screen of any computing device, including the likes of PCs, smartphones, tablets, and so on). A web browser application executes on a client device to which the display belongs, and that is rendered on-screen as web browser window 1701. An exemplary web page 1702 is rendered in browser window 1701, this being rendered from data obtained from a plurality of sources (for example including a primary source of web page data, and various secondary sources, including advertising servers and the like). In this example, the web page is a web page configured to allow the selection and purchase of clothing, and a clothing selection interface 1703 is rendered from data obtained from a clothing vendor web server 1720. For example, this provides images and descriptions of various garments, an ability to add garments to a “basket”, and so on, as is conventional in the context of online shopping interfaces.

In addition to clothing selection interface 1703, the web page provides a sizing widget 1704, which is rendered from data downloaded from a server other than server other than server 1720, or, in other words, a server other than that which provides the clothing selection interface . This sizing widget is, in the present embodiment, rendered based on close obtained from body scan data management server 1610. However, it will be appreciated that it may also be obtained from another server which obtains body scan data from server 1610 or otherwise.

The sizing widget which integrates with a third party, or affiliate partner, website to provide information related to garment sizing for a specific user (i.e. shopper). The user performs a login via server 1610 (in some cases manually via interaction with the widget, and in some cases automatically via a locally stored token accessed by the widget), to identify themselves and have their body measurement data retrieved server 1610. These measurements are preferably calculated based on a previous 3D body scan, as described above. In some cases there is functionality to enable manual entry of measurements via the widget (optionally available to non-registered users also). The widget then provides garment sizing information (and/or recommendations), for example in the form of a recommended size, and/or fit, and/or relevant user body measurements. This in some embodiments includes a visual representation displaying how the garment would fit the identified user at predetermined locations (for example a 2D or 3D representation of the user's size/shape relative to the garment's size/shape. The sizing recommendation is calculated based on the garment detail, associated sizing rules, available sizes, and the user's body measurements. Garment sizing information is provided by the vendor (in some cases via vendor web server 1720) based on a predefined protocol (for example an electronic form that received garment size information, objectively defined sizing charts, and so on). In some cases garment sizing information is automatically deduced via extraction of data from a vendor website.

This example allows users to obtain personal sizing information and recommendations via a variety of websites, without having to share their personal sizing information with any of the websites. The users' specific personal details are isolated from the vendor, by way of the embedded widget. This is useful for both users and for an administrator of server 1610. In the context of the latter, there is specific utility in keeping valuable information they hold secure, such that the service of repeatedly providing that information may be monetised appropriately.

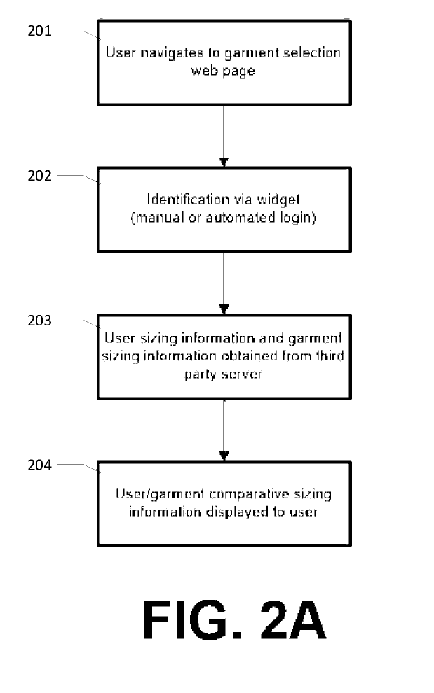

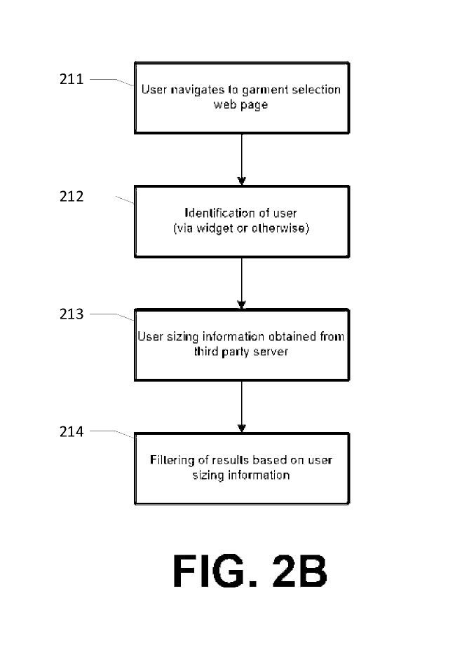

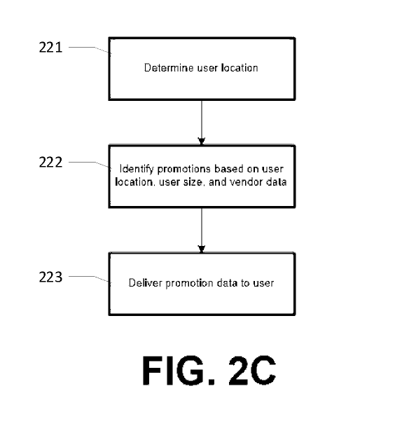

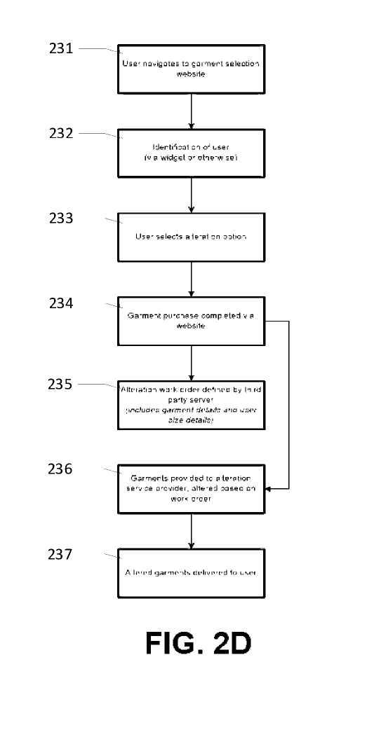

In some embodiments data provided by server 1610 (via the sizing widget or otherwise) is used to assist filtering available clothing options by reference to a user's size (see example in FIG. 2B). For example, only clothing available in sizes suitable for a user are displayed (either by default, or subject to a user command).

The widget preferably is configured to remember the user's details, allowing them to continue browsing the third party, or affiliate partner's, website and receive updated garment sizing information.

An exemplary method is shown in FIG. 2A. Functional bock 201 represents a processing including receiving data representative of user navigation to a particular web page, being a web page that is configured to deliver a sizing widget. This leads to execution of computer executed code associated with the sizing widget (for example at least a portion of such data is downloaded to the user's device, and rendered/executed through the user's web browser application). Functional bock 202 represents a processing including identification of the user via the widget (for example in user data 1612, provided by server 1610). This may be an automated login (for example where either the user's device or a web server maintains accessible credential data that enables the widget to identify the user) or a manual login (for example where a user is prompted to input credentials into a specified field or fields, provide biometric input, or the like). Based in identification of the user, functional block 203 represents a process including obtaining user sizing information (and in some embodiments garment sizing information) from server 1610. The precise nature of data obtained by the widget from server 1610 varies between embodiments, however at a functional level it enables data to be rendered in the user's web browser that provides user-specific sizing information for garments (and/or other products) advertised on the relevant website. In the example of FIG. 2A, user-to-garment comparative sizing information is displayed to the user (this is, in some embodiments, presented graphically). In another embodiment, the widget feeds data to the web page, thereby to enable the web page to provide user-specific sizing information and/or recommendations.

### Exemplary Affiliate/Tailoring Approval Widget

Following on from the preceding example, in some cases server 1610 provides an affiliate/tailoring approval widget which integrates with a third party, or affiliate partner, website and enables users to share certain body measurements with an affiliate/tailoring business.

In some embodiments, a user (i.e. shopper) is identified via the widget (or, in further embodiments, via alternate technical mans) to identify themselves and verify that they are willing to share their body measurements with an affiliate/tailoring business. The affiliate/tailoring business then receives a notification to alert them that the member has shared their measurement data. The widget provides the affiliate/tailoring business with a unique member identifier, allowing them to identify the user and securely request their body measurement data. This allows for the tailoring of custom clothing based on a user's specific sizing needs. The member's body measurement data is in some embodiments supplied to affiliates in real time, and in other embodiments at a later stage. Access to the body measurements is in some embodiments provided for a limited time period.

### Affiliate/Tailoring Approval Backend Portal

In some embodiments server 1610 provides a secure online portal/website which allows affiliate partners (e.g. tailoring businesses, clothing vendors, and the like) to login and access certain member body measurements belonging to members.

The system is configured such that affiliates are enabled only to access body measurement data belonging to members who have pre-approved their data to be shared with the specific affiliate. Affiliates who access the portal must are subjected to an approval process; and each affiliate request to view member measurement data is recorded. Affiliates are in some embodiments enabled to view the member measurements via a web browser, and request them to be emailed to their account or downloaded in another format.

### Size-Based Filtering

As noted, in some embodiments data provided by server 1610 (via the sizing widget or otherwise) is used to assist filtering available clothing options by reference to a user's size. An example is provided in FIG. 2B.

Functional bock 211 represents a processing including receiving data representative of user navigation to a particular web page, which in some examples is a web page that is configured to deliver the sizing widget (as discussed above). Functional bock 212 represents a processing including identification of the user thereby to enable access to their data at server 1610 (via the widget , or via another technological means). Based in identification of the user, functional block 213 represents a process including obtaining user sizing information (and in some embodiments garment sizing information) from server 1610. Then, search results and/or displayed garments are filtered such that only items suitable for the user, based on his/her size, are displayed. For example, only clothing available in sizes suitable for a user are displayed (either by default, or subject to a user command). In one embodiment, a website that advertises for sale various items that are provided in multiple size-based configurations receives the input representative of a user's size, such that a given product is only displayed to the user in the case that a size option appropriate for the user is currently available (for example based on inventory data).

### Exemplary Measurement-Based Promotional Methods

In some embodiments, a proximity-based matching algorithm is applied thereby to identify vendors and/or specific garments (and/or other items) proximal a user (based on mobile device location, assessed using GPS and/or other means) based upon their body scan data and/or other parameters. This is preferably used thereby to assist a user in identifying garments suitable for their size in nearby locations, in some cases limited to garments for which special prices or the like are being offered. This, in some embodiments, is based upon matching of fit parameters provided by vendors and sizing data determined for a given user.

In some embodiments this algorithm is applied via a mobile app, for example thereby to provide a “Find clothes nearby” functionality. Recommendations may be filtered by brand, colour, price, discount, and/or other parameters. Recommendations may will take into account factors including but not limited to
Previous purchases;
Purchases made by people of similar measurements; and
Purchasing preferences indicated by the user.

In further embodiments proximity-based matching is implemented in broader context, for example in relation to health/fitness applications as opposed to clothing sizes.

An exemplary method is shown in FIG. 2C. Functional block 221 represents a process including determining user location. For example, this may include using technologies such as geofencing, location-defined BLE tags (or other location defining tokens, such as RFID), GPS monitoring in response to a user interaction and/or automated rule, and so on. Based on the user's location, one or more “promotions” are identified at 222 based on a combination of (i) user sizing data derived from body scanning; and (ii) vendor data that defines criteria for promotions. Promotion data is delivered to the user at 223. Promotion data may include, delivering to the user's mobile device, data that is configured to be rendered: as a message (for example SMS, iMessage, MMS, email etc); within a predefined app (for example an app associated with a vendor, an app associated with a body scan provider, or the like); as a notification message, and so on.

### Exemplary Alterations Management Process

In some embodiments, body scan data (for example user sizing data) is used thereby to assist in providing alternations services to users. As with embodiments described above, this may include the user of a widget-based approach whereby embedded objects provided in vendor web pages. An exemplary approach is illustrated in FIG. 1C.

In the example of FIG. 1C, a user operates a client terminal 1901 thereby to interact with a clothing vendor web portal 1902 (for example a website from which clothing garments are able to be purchased). Body scan management data server 1903 (or in some embodiments a server associated with a body scan data management service) provides code indicative of an alterations widget, which is rendered in a web page viewed by the client (the code in some embodiments is downloaded directly to the client terminal, as opposed to being downloaded via portal 1902). This provides an option for the client to “purchase altered clothing” or the like. In some cases this option is able to be applied to individual selected garments, optionally with further user-specified customisation options.

In the case that the user selects an option to purchase altered clothing for one or more garments, those garments (and optionally other garments in a common order) are provided to an alternations agent 1904 for altering prior to delivery to a delivery address 1905 designated by the user. Server 1903 provides user sizing data to agent 1904 (directly or indirectly) thereby to facilitate the alterations. For example, in one embodiment server 1903 provides work order data to agent 1904, this specifying an order placed via portal 1902, garments for which alteration is required (and any user-defined customisation options), and user sizing information derived from body scan data. The ultimate delivery address 1905 may also be provided.

In some embodiments, alterations functionality is integrated such that the overall user checkout procedure is substantially unaffected. The consumer need only select a “purchase altered clothing”, which automatically adds a service charge to a billing total amount (unless the service is provide complimentarily). This consumer continues with the purchase as per usual, and the shipping of garments to agent 1904 (or other delivery), and charging of the vendor for alterations, are handled as back-office operations (preferably automated) without concern to the user.

An exemplary method is shown in FIG. 2D. Functional block 231 represents a process including a user navigating to a garment selection website. Functional block 232 represents identification of the user, with respect to user data at server 1610. Having selected a garment for purchase, a user selects an “alteration” option at 233, for example a checkbox or the like presented during a checkout procedure which enables a user to indicate that they wish for the garment to be altered. This, in some embodiments, includes functionality to select alteration types, and in some embodiments adds an additional monetary charge to the user's invoice. Garment purchase is completed at 234. This triggers (directly or indirectly) the generation of an alteration work order at 235, which provides to a predetermined garment alteration service provider details of the garment and details of the user's size (as derived from body scan data). Functional block 236 represents a process whereby a garment (or garments) for alteration are provided to the garment alteration service provider, such that they can be altered based on the work order. The altered garments are then delivered t the user. For example, in some embodiments addressed packaging for that delivery (optionally with pre-paid postage) is delivered to the garment service provider along with the garment(s).

### Exemplary Client Server Framework

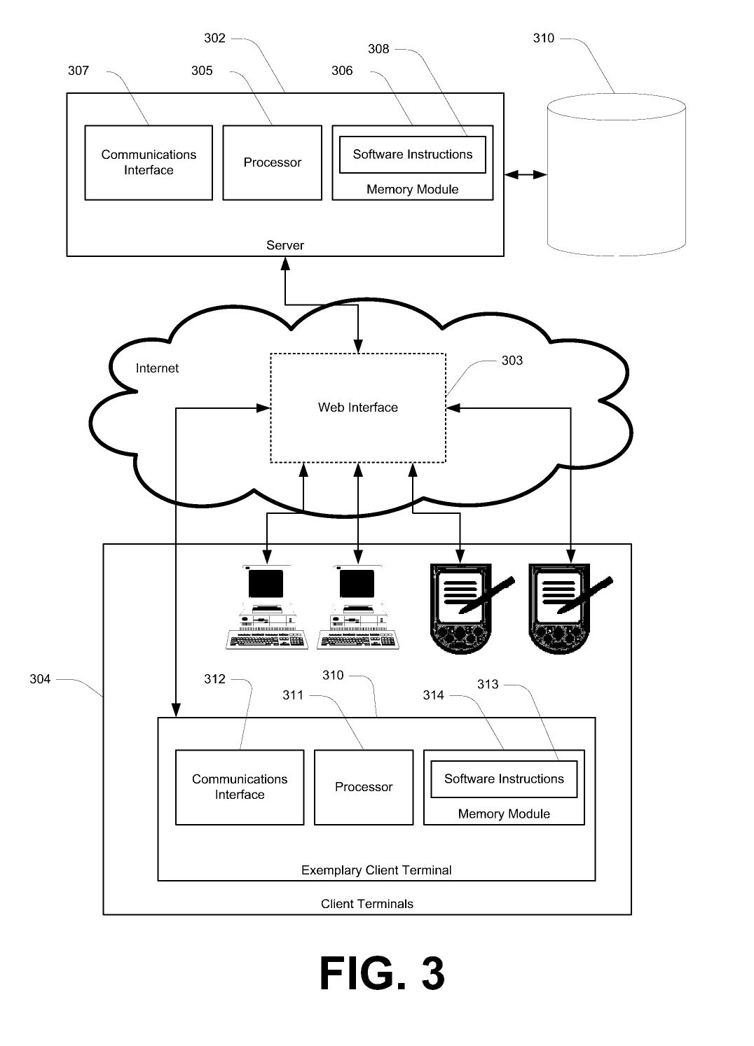

In some embodiments, methods and functionalities considered herein leverage a client-server framework, for example as illustrated in FIG. 3.

In some embodiments, methods and functionalities considered herein are implemented by way of a server, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

### Conclusions and Interpretation

It will be appreciated that the disclosure above provides various significant devices, frameworks and methodologies for enabling user-driven determination of body size and shape information and utilisation of such information across a networked environment.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer implemented method for managing body scan information, the method including:
receiving, from a plurality of distributed scanning booth systems, body scan data respectively defined for a plurality of users;
maintaining user record data, wherein the user record data is configured to include, for each of a plurality of users, user registration data and user body scan data; and
in response to a request from a third party website, the request being representative of a user identifiable in the user record data, providing response data that is configured to enable filtering of items for display to a given user via the third party website based on the user's size as derived from the body scan data.

2. A method according to claim 1 wherein the filtering includes displaying only items that are available in a configuration suitable for the user based on the on the user's size as derived from the body scan data

3. A method according to claim 1 wherein size includes both size and shape.

4. A method according to claim 1 wherein size includes size based on a 3D avatar generated based upon the user body scan data.

5. A method according to claim 1 including providing a visual representation of garment size relative to the user's size.

6. A method according to any preceding claim wherein the user interface functionality is provided to the user as a widget embedded in a third party webpage.

7. A method according to claim 6 wherein the widget provides a login functionality thereby to enable the user to self-identify.

8. A computer implemented method for displaying garment information to a user, the method including:
providing an interface that enables the user to view garment information;
identifying the user;
communicating with a remote server that maintains access to user record data, wherein the user record data is configured to include, for each of a plurality of users, user registration data and user body scan data; and
filtering of garments for display to a given user based on the user's size as derived from the body scan data.

9. A method according to claim 8 wherein the filtering includes displaying only items that are available in a configuration suitable for the user based on the on the user's size as derived from the body scan data

10. A method according to claim 9 wherein size includes both size and shape.

11. A method according to claim 9 wherein size includes size based on a 3D avatar generated based upon the user body scan data.

12. A method according to claim 9 including providing a visual representation of garment size relative to the user's size.

13. A computer implemented method including:
receiving, via an widget embedded in a garment vendor web page, data indicative of a garment purchased by a user; and
providing to an alteration service provider data indicative of the garment and data indicative of sizing information for the user, wherein the sizing information is derived from centrally management body scan information.

14. A method for coordinating alteration of garments, the method including:
maintaining a repository of sizing information for users, wherein the sizing information is derived from body scans performed at a plurality of distributed locations;
maintaining communication with a plurality of online vendor portals which enable purchase of garments; and
enabling a given user of a given vendor portal to request alteration of a given purchased garment via the vendor portal; and
defining data indicative of instructions for alteration of the garment by a alteration service provider, wherein the instructions include sizing information for the user.

15. A computer implemented method including:
determining current location information for a mobile device on which a mobile-app is executing;
presenting data indicative of one or more promotions, wherein the one or more promotions are selected based upon:
(i) the determined current location;
(i) data derived from body scan information managed at a central server, which maintains body scan information for a plurality of users collected from a plurality of body scanning hardware units; and
(iii) vendor promotional parameters.

16. A computer implemented method for managing body scan information, the method including:
receiving, from a plurality of distributed scanning booth systems, body scan data respectively defined for a plurality of users;
maintaining user record data, wherein the user record data is configured to include, for each of a plurality of users, user registration data and user body scan data; and
providing a user interface functionality, viewable via a third party platform, which enables a given user to view a relationship between the user's size, as determined from user body scan data, and a garment size.

17. A method according to claim 16 wherein size includes both size and shape.

18. A method according to claim 16 wherein size includes size based on a 3D avatar generated based upon the user body scan data.

19. A method according to claim 16 including providing a visual representation of garment size relative to the user's size.

20. A method according to claim 16 wherein the user interface functionality is provided to the user as a widget embedded in a third party webpage.

21. A method according to claim 20 wherein the widget provides a login functionality thereby to enable the user to self-identify.

22. A computer implemented method for displaying garment information to a user, the method including:
providing an interface that enables the user to view garment information;
identifying the user;
communicating with a remote server that maintains access to user record data, wherein the user record data is configured to include, for each of a plurality of users, user registration data and user body scan data; and
providing a user interface object which enables the user to view a relationship between the user's size, as determined from user body scan data, and a garment size.

23. A method according to claim 22 wherein size includes both size and shape.

24. A method according to claim 22 wherein size includes size based on a 3D avatar generated based upon the user body scan data.

25. A method according to claim 22 including providing a visual representation of garment size relative to the user's size.

26. A computer system or computer readable carrier medium configured to perform a method according to any preceding claim.
